(19) United States
(12) Patent Application Publication
(10) Pub. No.: US 2020/0062563 A1
(43) Pub. Date: Feb. 27, 2020

(54) Vehicle Hard Top Lift

(71) Applicant: Anthony L. Roland, Anniston, AL (US)

(72) Inventor: Anthony L. Roland, Anniston, AL (US)

(21) Appl. No.: 16/244,961

(22) Filed: Jan. 10, 2019

Related U.S. Application Data
(63) Continuation-in-part of application No. 16/109,598, filed on Aug. 22, 2018, now abandoned.

(51) Int. Cl. B66F 7/26; B60J 7/10

(52) U.S. Cl. CPC B66F 7/26; B66C 23/36; B60J 7/106

(57) ABSTRACT

A vehicle hard top lift device comprising a receiver bar with a pivot post on its upper surface opposite a receiver hitch, a mast insertable onto said pivot post, a pivot support arm pivotally connected to the top of the mast, and a linear actuator coupled to said mast and said pivot support arm. The hard top lift device further comprises an extension bar insertable and slidable within the end of the pivot support arm and said extension bar connected to a lift frame purposed to be placed inside the rear cargo area of vehicle and up against the interior roof of a hard top. Capture plates and/or capture plate channel located on the top of the pivot support arm will engage the back bottom edge of the hard top to prevent the hard top from sliding off the lift frame. A user will through a vehicle powered electrical power source operate a switch which will cause the linear actuator to remove or install a hard top on to a vehicle with very minimal effort with the raising and lowering action of the linear actuator with the pivot arm and rotational mast on the pivot point for placement of a hard top away from a vehicle or staging for installation of a hard top onto a vehicle.

### CROSS-REFERENCED TO RELATED APPLICATIONS

This application is a Continuation-in-Part of U.S. Non-Provisional application Ser. No. 16/109,598 and claims the benefit of priority in its entirety of U.S. Non-Provisional application Ser. No. 16/109,598 filed on Aug. 22, 2018.

### FEDERALLY SPONSORED RESEARCH

None

### SEQUENCE LISTING

None

### FIELD OF THE INVENTION

The invention relates to a device for removing and installing a removable hard top on a vehicle. More specifically the invention is a vehicle hard top lift device designed to drastically reduce the difficulty of removing and installing a hard top from and to a vehicle.

### BACKGROUND OF THE INVENTION

There are various vehicles that have been manufactured such that a portion of the roof or top canopy and sidewall of the vehicle is removable. Most prevalent would be the various JEEP® model sport utility vehicles that are common on roadways today. These vehicles can be fitted either with a removable hard top or a fabric and plastic soft cover. Soft covers function as intended and are easily removable, but they cannot offer rigidity and clear windows found in normal car windows. Hard tops offer rigidity and clear windows but are difficult and cumbersome for a single person or even two persons to remove. Additionally, hard tops or camper shells are commonly used on pick-up trucks with beds and present the same challenges of removal and installation by a single person. Vehicle owners travel to various destinations for recreation and they desire to drive their vehicle with the top removed to enjoy the breeze and weather. Further, a vehicle owner may need their rear compartment open and not covered. However, nothing exists in the art that allows easy, efficient and safe installation and removal of a hard top in various locations. What is needed in the art is a vehicle hard top lift device that is easy to use, requires minimal physical effort by an operator, is inexpensive to manufacture, and one that is portable. Another problem in the art that the present invention overcomes is that it requires no straps, ropes, guy lines, cables or any other similar connection type or install point on the hard top of the vehicle. Such connection types are cumbersome, get tangled, are subject to failure, can damage a hard top and its seals, and can cause tipping, droppage and/or breakage of a vehicle hard top and can create unsafe conditions. Additionally, what is needed in the art is a hard top lift device that more quickly allows the vehicle hard top to clear any roll bar that is in the rear compartment of the vehicle by allowing the hard top to tilt rearward during removal such that the front bottom edge of the hard top is lifted higher quicker than just lifting the vehicle hard top straight off of the vehicle parallel to the ground. What is needed in the art is a hard top lift device that provides a stable lifting solution that is not subject to failure.

### SUMMARY OF THE INVENTION

The present invention is a vehicle hard top lift device wherein there is a receiver bar connected to a vehicle hitch receiver whereby said receiver bar has a pivot post on its top surface opposite of the where the receiver bar is attached to the vehicle receiver. Installed onto the pivot post is a mast that is hollow on its bottom end and extends upward for a distance to an interior pivot plate. There is a bracket on top of the mast for a pivot connection with a pivot support bar. There is a diagonal bracket on the pivot support bar that connects to a linear actuator on its piston end and an actuator bracket located on the mast for connection to a linear actuator such that the linear actuator is connected to the mast and the pivot support bar and said linear actuator raises and lowers the pivot support bar. There is an extension bar that slidably connects into the pivot support bar on one end and the extension bar is connected on its other end to a lift frame that is insertable and retractable inside a rear window of a vehicle such that the top of the lift frame comes into contact with the interior roof of the vehicle hard top and two capture plates nest around the back bottom edge of the hard top. The hard top lift device has an electrical power source and switch that are connected to the linear actuator to power the linear actuator. Once the lift support frame has made flush contact with the interior top of the hard top and has been positioned appropriately through use of the actuator and the extension bar slidable connection with the pivot support bar, an operator can commence to lift the hard top to a position where it is higher than the interior roll bars of the vehicle. The operator then grasps handles located on the mast and rotates the mast via said handles and moves the hard top out and away from the vehicle. The operator then lowers the hard top by use of the actuator to a position where temporary support stands can be placed under the hard top.

### BRIEF DESCRIPTION OF THE DRAWINGS

FIG. 1 is a perspective view of the vehicle hard top lift engaged into a vehicle rear cargo area and in contact with the upper surface of the hard top.

FIG. 2 is an exploded perspective view of the vehicle hard top lift and associated components.

FIG. 3 is a rear partial cross-sectional view of the mast of the vehicle hard top lift.

FIG. 4 is a rear partial cross-sectional view of an alternate embodiment of the mast of the vehicle hard lift.

FIG. 5 is a perspective view of the vehicle hard top lift in operation and placement of the hard top.

FIG. 6 is a perspective view of the vehicle hard top lift disassembled and ready for storage in a portable container.

FIG. 7 is a perspective view of the capture plate channel.

FIG. 8 is a side elevation of the capture plate channel.

FIG. 9 is a top plan view of the capture plate channel.

FIG. 10 is a side elevation of an alternate embodiment of the capture plate channel.

FIG. 11 is a perspective view of an alternate embodiment of the capture plate channel mounted on the pivot support arm.

### DETAILED DESCRIPTION

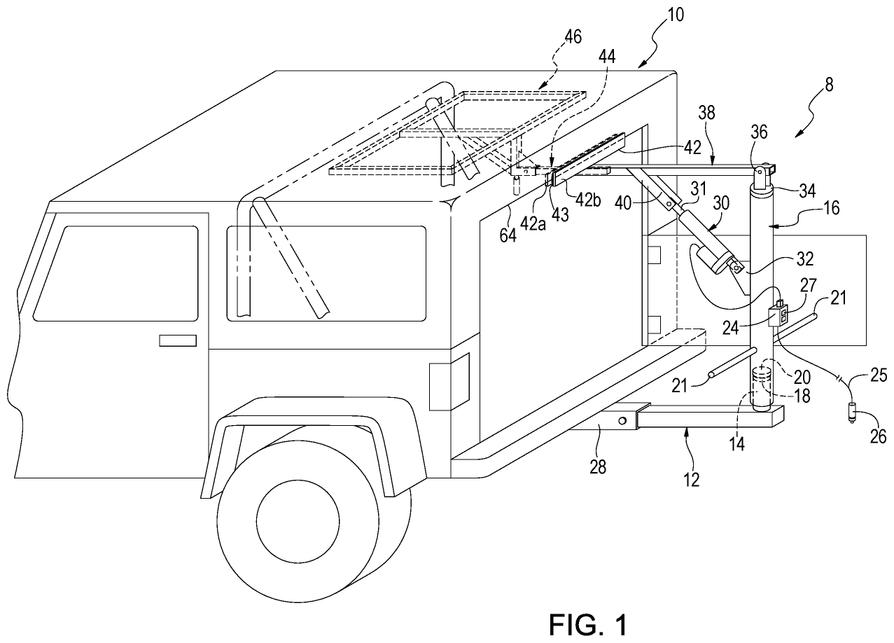

Referring now to FIG. 1, there is shown a perspective view of a hard top lift device 8 inserted into a vehicle rear cargo space. As shown, the hard top lift device 8 has a receiver bar 12, which the term “receiver bar” can for purposes of this application be used interchangeably with the term “horizontal member”. The receiver bar 12 in one embodiment is a square tube. The receiver bar 12 connects into a vehicle receiver hitch 28 on one end. On the opposite end of the receiver bar 12 is a pivot post 14 located on the receiver bar 12 top surface. The pivot post 14 is a cylindrical tube made of metal and welded onto top surface of the receiver bar 12. On top of the pivot post 14 is a pivot plate 18 welded onto the pivot post 14. The pivot plate 18 gives the pivot post 12 a solid upper surface on the pivot post 14 and allows the pivot post 14 to be made out of circular tubing instead of a solid piece of metal. Sized and adapted to be installed onto the pivot post 14 is a mast 16 of cylindrical shape that is of a diameter slightly larger than the pivot post 14 such that the mast when installed onto the pivot post 14 can rotate back and forth. For purposes of this application, the term “mast” can be used interchangeably with the term “vertical tube”. In one embodiment of the invention, the mast 16 has an outer diameter of three inches and the pivot post 14 has an outer diameter of two and a half inches. Located in the bottom interior of the mast 16 is an interior pivot plate 20 welded by use of a plug weld such that it creates a meeting and stopping point of the pivot post 14 and pivot plate 18 and the interior pivot plate 20. The interior pivot plate 20 comes to rest on the pivot plate 18 such that the bottom edges of the mast 16 do not touch the receiver bar 12. Shown also are handles 21 that are used to rotate the hard top lift device 18 when removing or installing a vehicle hard top.

Located at the top of the mast 16 is a mounting plate 34 and a bracket 36 joined to said mounting plate 34 that is used to connect to a pivot support bar 38. For purposes of this application, the term “pivot support bar” can be used interchangeably with the term “pivot arm”. The mounting plate 34 is a circular plate of metal welded to the upper end of the mast 16 so as to create a solid mounting connection for bracket 36. Bracket 36 is welded to the mounting plate 34. The pivot support bar 38 is joined to the bracket 36 of the mast 16 by using a connector 62 such as a wire snap safety pin, bolt and nut or wing nut, a clevis pin, wire lock pin, a hitch pin and any other similar quickly installable connector 62. The mast 16 also has located on its anterior sidewall facing the vehicle an actuator bracket 32. Located on the pivot support bar is a diagonal bracket 40. A linear actuator 30 is connected to the diagonal bracket 40 on its piston end 31 with a connector 62 and connected to the actuator bracket 32 at the base end of the linear actuator 30 with a connector 62. The diagonal bracket 40 length allows the linear actuator 30 piston additional length to move the pivot support arm 38 as well as offers additional strength and bracing in the middle of the pivot support arm 38 such that it will not flex when lifting a hard top 10. The hard top lift device 8 is supplied power via a vehicle's direct current voltage supply through a cord 25 and adapter 26 that is commonly provided in cigarette lighter adapter sockets found in vehicles. The linear actuator 30 provides a user with the mechanical advantage of a lever whereby the connection of the pivot support bar 38 to the bracket 36 is the fulcrum, the applied force is where the linear actuator 30 connects to the diagonal bracket 40 of the pivot support bar, and the vehicle hard top is the load that is supported by a lift frame 46 as discussed more fully in detail below. A hard top 10 weighs approximately 94 pounds and the linear actuator 30 must be sized appropriately to exert the necessary force required to lift the hard top 10. In one embodiment the linear actuator 30 has a 12 Volt and 3 Ampere rating and can have a weight rating of 1500 newtons and a piston travel of 12 inches. In addition to the importance of matching the linear actuator 30 to the weight load of a hard top 10, the linear actuator 30 speed is important because a linear actuator 30 that too quickly advances the piston end 31 could become unsafe while removing a hard top 10 by causing jerky movements that could dislodge hard top 10 from the lift device 8. A linear actuator 30 that is too slow would require excess time spent by an operator. In one embodiment of the invention, an actuator 30 can have a travel speed of 5.7 mm/second.

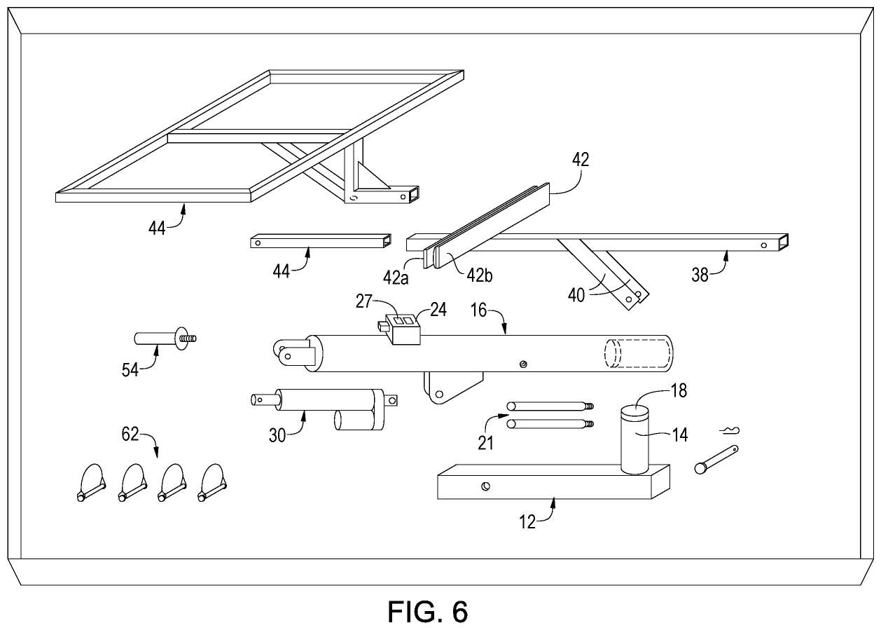

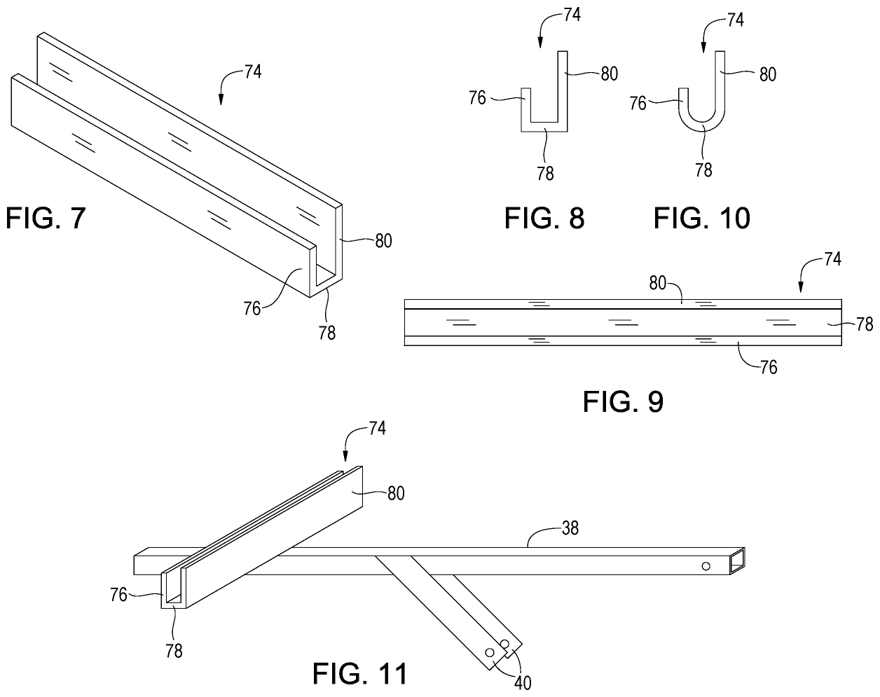

The pivot support bar 38 or alternatively termed the “pivot arm” 38 has on its top surface, and forward of the diagonal bracket 40, two capture plates 42 whose purpose is to allow the back bottom edge 64 of a vehicle hard top 10 to rest within the capture plates 42 to provide additional stability when removing and/or installing a vehicle hard top. The capture plates 42 in conjunction with a lift frame 46 allow the vehicle hard top 10 to tilt and be lifted at an angle without the hard top 10 sliding off. The capture plates 42 prevent a hard top 10 from sliding rearward off the lift frame 46 if the hard top is angled rearward and they prevent a hard top 10 from sliding forward and off of the lift frame when the hard top is lowered below horizontal. Other equivalents could be used in place of the capture plates 42 such as a flat plate mounted on the pivot support arm 38 whereby there are vertical pegs installed onto the top of the flat plate and said vertical pegs could be in parallel rows such that one row of pegs would nest behind the back bottom edge 64 of the hard top 10 and another row of vertical pegs that would nest in front of the back bottom edge 64 of the hard top. Further, the capture plates 42 could be of various shapes and sizes just so long that there is a barrier directly behind the back bottom edge 64 of the hard top 10 and there is a barrier in front of the back bottom edge 64 of the hard top 10 and also must be sized as to accommodate the dimensions of the hard top 10 and rear cargo area of a vehicle. Additionally, a capture plate 42 pad 43 is installed within and onto said capture plates 42 to avoid scratching of the vehicle hard top 10. In an alternate embodiment as shown in FIGS. 6 and 7, there is shown a capture plate channel 74 comprising a front plate 76, a bottom plate 78 and a rear plate 80 that is attached to the top surface of the pivot arm 38 and is purposed for locating the back bottom edge 64 of a vehicle hard top 10 between the front plate 76 and rear plate 76 and resting on the bottom plate 80. The capture plate channel 74 can be formed from a singular piece of material, preferably of metal but other materials could be used, and is joined to the top surface of the pivot arm 38 by welding or adhesive. The capture plate channel 74 can also be formed from three pieces of metal via welding. The capture plate channel 74 can also be formed of high strength plastic such as ABS plastic and other similarly suited plastics and can manufactured through the process of injection molding. Alternatively, the capture plate channel 74 can be removably attached to the pivot support bar 38 by having a threaded aperture(s) in the bottom plate 80 that aligns with a corresponding threaded aperture in the top surface of the pivot arm 38 such that a threaded bold or connector can join the capture plate channel 74 to the pivot arm 38 but allowing for removal of the capture plate channel 74 for easier storage and portability in an appropriate storage container. In a preferred embodiment, the front plate 76 has a height of 1.5 inches and the rear plate 80 has a height of 2.5 inches. The gap or space between the front plate 76 and the rear plate 80 is 77777 FIG. 8 shows an additional embodiment where the capture plate channel is cross sectionally generally semi-circular in shape or semi-elliptical in shape with the front plate 76 having a height of 1.5 inches and the rear plate 80 having a height of 2.5 inches. The pivot support bar 38 is a hollow square tube in one embodiment and is adapted to receive an insertable extension bar 44 whereby said extension bar 44 is insertable into the pivot support bar 38 on one end and is connected to a lift frame 46 on the other end of the extension bar 44. Metal is a preferred material for use in fabrication of the vehicle hard top lift device 8. Steel is a good choice of metal material to be used.

The height of the mast 16 is within the range of 43 inches to 44 inches although 43.5 inches is optimum. This mast 16 height allows a perfectly level horizontal connection with the lift frame 46 and pivot support bar 38 and capture plates 42 when first encountering a hard top 10 on a vehicle. This height allows for level seating of the back bottom edge 64 of the hard top 10 in the capture plates 42 and the interior of the hard top 10 roof on the lift frame 46. It is also very important when reinstalling a hard top 10 to have a perfectly level connection of the hard top 10 with the vehicle such that a weather seal on the bottom edge of the hard top 10 meets the vehicle in flush fashion. Any other height used for the mast would not allow proper installation of a hard top 10 onto a vehicle.

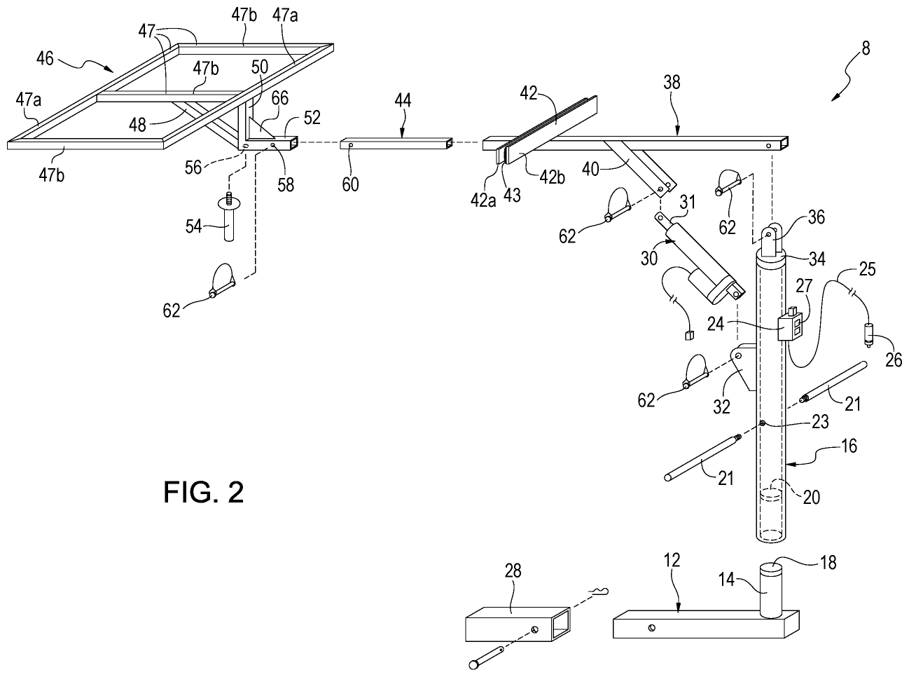

Referring now to FIG. 2, there is shown an exploded view of the hard top lift device 10 showing the individual components and how they assemble and work together. The lift frame 46 has an upper frame portion 47 that is flat and purposed for lifting up in flush contact the interior roof of a vehicle hard top. In one embodiment of the invention, the upper frame portion 47 of the lift frame 46 is rectangular in shape and consists of two parallel bars 47a joined perpendicularly to three parallel bars 47b whereby the two parallel bars 47a are longer than the perpendicular three parallel bars 47b. In one embodiment, the two parallel bars 47a are 32 inches long each. The three parallel bars 47b consist of an two outer bars and one inner bar where the outer bars are fifteen inches on the outer bars and twelve and three-quarters inch long on the inner bar. However, other upper frame portion 17 shapes could be used. Additionally, cloth, felt, rubber, cork or other protective materials can be installed onto the top of the upper frame portion 47 to create more resistance between the connection of the lift frame 46 and the interior roof of the hard top 10 and to prevent any damage to the hard top 10. The lift frame 46 also has a diagonal support 48 connecting the upper frame portion 47 to a post 50 and connected on to the bottom of the post 50 is a perpendicular horizontal lift frame receiver bar 52 adapted to receive and connect to the extension bar 44. The post 50 and diagonal support 48 allow the upper frame portion 47 to be located at higher elevation so as to engage the interior roof a vehicle while simultaneously the parallel capture plates 42 engage the back bottom edge 64 of the hard top 10. The lift frame 46 in one embodiment would be made of square steel tubing. The upper frame portion 47, diagonal support 48 and post 50 would be made of one inch by once inch square tubing having a thickness of ⅙ inch. The lift frame receiver bar 52 in one embodiment would be made from one and one-quarter inch by one and one-quarter inch square tubing having a thickness of one-eighth of an inch. There is also a gusset 66 installed and welded at the junction of the post 50 and lift frame receiver bar 52 to provide structural integrity.

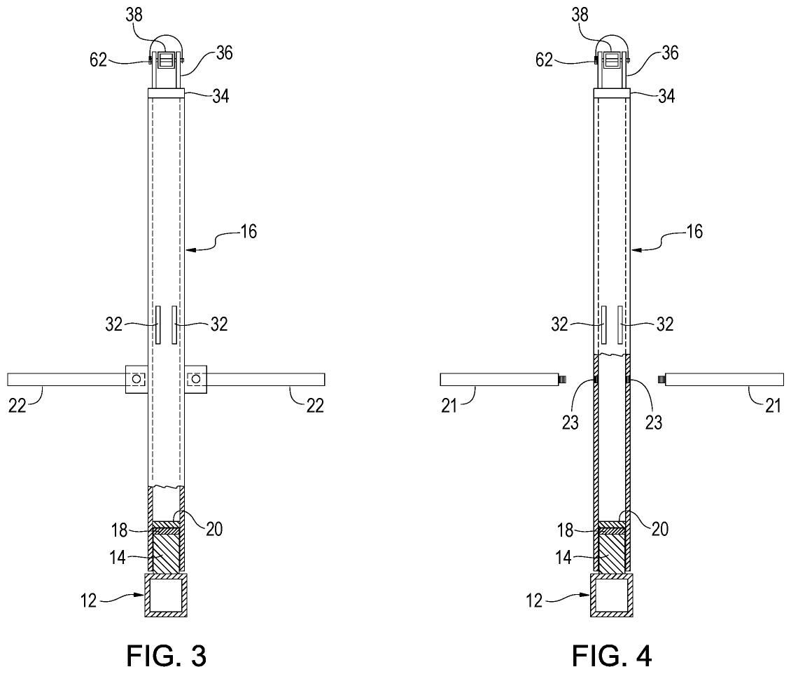

Also shown is a handle 54 that is threadably connected to a threaded aperture 56 on the underside of the lift frame receiver bar 52. Also shown is a transverse aperture 58 located on the side of the lift frame receiver bar 52 that is purposed for connection with a transverse aperture 60 located on the end of the extension bar 44 with a connector 62. The handle 54 is removable for portability and storage. The handle 54 is purposed for sliding the lift frame into the vehicle and positioning the lift frame in an appropriate position underneath the hard top interior roof. This is achieved through the slidable connection the extension bar 44 has with the pivot support bar 38. The extension bar 44 in one embodiment is twenty inches long which provides adequate length for insertion of the lift frame 46 into the interior of vehicle rear compartment by way of the extension bar 44 ability to be retracted from its insertion into the pivot support arm 38 to an adequate length for proper placement into the rear vehicle cargo area. Further shown in FIGS. 1 and 2 are handles 21 that are used to rotate the mast 16 either left or right when either installing or removing a vehicle hard top. The handles can either be permanently installed handles 22 as shown in FIG. 3 that are foldable or they can be rod handles 21 that have threaded ends that are adapted to be inserted into threaded apertures 23 located in the mast 16. Additionally, apertures can be formed in the mast 16 such that they align and are on opposite sides of the mast 16 and an appropriately sized metal rod can be inserted into said apertures such that a portion of the metal rod extends beyond the mast 16 on each side of the mast 16 and can be used as handles and provides for quick installment.

Referring now to FIG. 3, there is shown a partial cross-sectional view of the mast 16 whereby there is an interior pivot plate 20 shown. The interior pivot plate 20 is purposed to come into contact with and rest on the pivot plate 18 of the pivot post 14 such that fluid rotation of the mast from left to right whereby a hinge is created between the pivot post 14 and the mast 16. The interior pivot plate 20 is installed by using a plug weld method where the interior pivot plate 20 is inserted into the bottom of the mast 16 a distance slightly less than the height of the pivot post 14 and a welding torch or arc welder is used to weld the interior pivot plate 20 from the exterior of the mast 16. Also shown in FIG. 3 are handles 22 in their deployed position. Handles 22 are pivotably connected via a hinge to brackets that are mountable to the side of the mast 16.

Referring now to FIG. 4, there is a rear partial cross-sectional view of the mast 16 showing the pivot plate 18 in contact with the interior pivot plate 20 located in the mast 16. Also shown is an alternate embodiment of the invention whereby there are rod handles 21 that are connectable to the threaded apertures 23 by way of the rod handles 21 having threaded ends that screw into said threaded apertures 23 located on opposing sides of the mast 16.

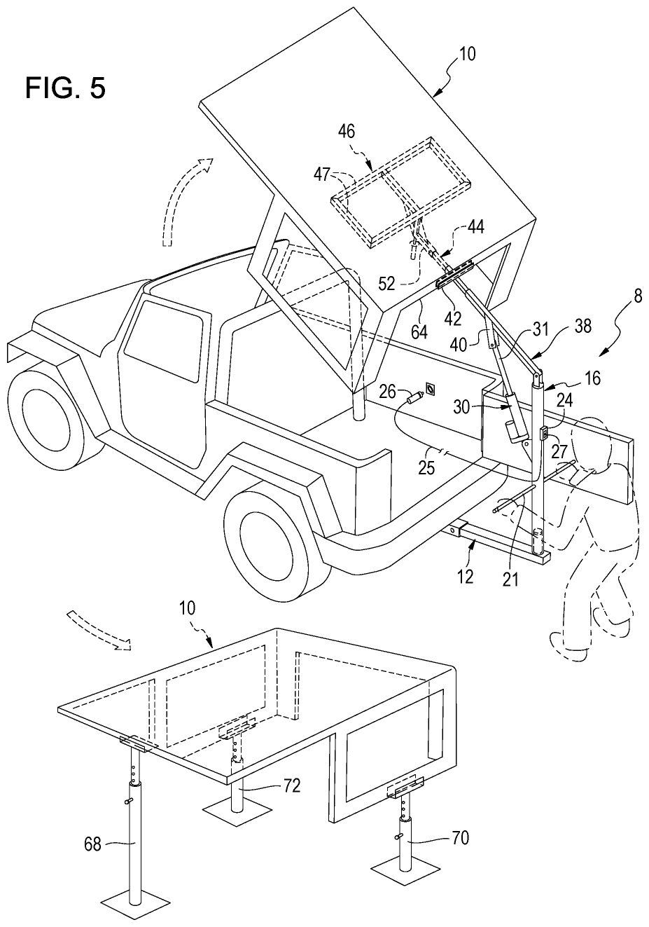

Referring now to FIG. 5, there is shown a user removing the vehicle hard top with the lift device 10. The user must first remove all bolts that attach the hard top to the vehicle. The rear cargo gate of the vehicle must then be opened before installation of the hard top lift device 10. In practice, a user inserts the receiver bar 12 in the vehicle hitch receiver 28. Next, the mast 16 is installed onto the pivot post 14 inserting the pivot post 14 into the bottom of the mast 16. The pivot support bar 38 is then installed onto bracket 36 by use of a connector 62. The linear actuator 30 is then connected to the actuator bracket 32 at the base of the linear actuator 30 and the piston end 31 of the actuator is joined to the diagonal bracket 40 of the pivot support bar 38. The extension bar 44 is joined to the lift frame 46 via a connector 62 and then the extension bar 44 is inserted into the end of the pivot support bar 38. Handle 54 is installed into the threaded aperture 56 on the receiver bar 52 of the lift frame 46. A direct current cord 25 coupled to an adapter 26 is connected to the vehicle electrical adapter socket. The cord 25 is then plugged into a power junction box 24 that is located on the mast 16 and said power junction box 24 has a switch 27 that a user can power the linear actuator 30 out and in. A user will use the switch 27 to power the linear actuator 30 to raise the pivot support bar 38 to position the parallel capture plates 42 flush around the back bottom edge 64 of a hard top 10. The next step is for a user to grasp the handle 54 of the lift frame 46 and advance the lift frame 46 into the interior rear cargo space and advance the linear actuator 30 outward to place the top surface of the upper frame portion 47 of the lift frame 46 in contact with the interior roof surface of the vehicle hard top 10. Once the lift frame 46 and capture plates 42 are in proper position, the user holds the switch in the up position to power the linear actuator 30 outwards which moves the hard top 10 upwards until the hard top 10 front bottom edge is higher than the vehicle roll bar. In one embodiment of the invention the capture plates 42 are parallel and there is a front capture plate 42a and a rear capture plate 42b. The rear capture plate 42b should have a height between two and three-quarter inches and three inches to give a hard top 10 adequate surface to nest against as it is raised at an angle. The front capture plate 42a has a maximum height of two inches due to spatial constraints within hard top back bottom edge 64 and the front capture plate 42a cannot be shorter than two inches as it would not adequately lodge against the back bottom edge 64 of the hard top in conjunction with the rear capture plate 42b. The capture plates 42 are welded onto the pivot support arm 38. In a preferred embodiment, there is a gap between the front capture plate 42a and the rear capture plate 42b having a distance of one and one half inches to two inches such that a protective pad 43 can be placed within the gap between the front capture plate 42a and the rear capture plate 42b. As the linear actuator 30 raises the hard top 10 off the vehicle and by nature of the design of the hard top lift device 8 and the raising of the pivot support bar 38, the hard top 10 is angled rearward and the parallel capture plates 42 prevent the hard top from sliding off of the top surface of the lift frame 46. This design also aids in faster clearance of the hard top 10 from a vehicle roll bar because the roll bar is located towards the front of the hard top 10 and the tilting of the hard top 10 provides that the front bottom edge of the hard top 10 is higher than the rear causing it to clear the roll bar quicker than lifting the hard top in a manner that is parallel to the ground which increases the height needed to lift the hard top 10. Once the hard top 10 is above and clear of the rollbar, a user will grasp the handles 21 or 22 and rotate the mast 16 either to the left or to the right depending on where they want the hard top to be lowered. The user will then use the switch 27 to lower the hard top 10 until the linear actuator 30 is almost exhausted of inward travel. A user will then place a front portable stand 68, a left portable stand 70 and a right portable stand 72 underneath the hard top 10 and lower the hard top 10 via the actuator 30 and the switch until the hard top 10 comes to rest of said portable stands 68, 70 and 72. A user will then grasp the handle 54 on the lift frame 46 and pull the lift frame 46 out from underneath the hard top 10. The afore-mentioned process can be reversed to install a hard top 10 with the hard top lift device 8 onto a vehicle.

Referring now to FIG. 6 there is shown the hard top lift device 8 collapsible support frame comprised of its disassembled into its individual components. The present invention is very easy to install and break down for storage and transport. The hard top lift device 8 can be stored in a soft side bag or a hard case and is portable and stowable either in interior of the vehicle, on a vehicle hitch rack or on a roof rack.

The principles, embodiments, and modes of operation of the present invention have been set forth in the foregoing specification. The embodiments disclosed herein should be interpreted as illustrating the present invention and not as restricting it. The foregoing disclosure is not intended to limit the range of equivalent structure available to a person of ordinary skill in the art in any way, but rather to expand the range of equivalent structures in ways not previously contemplated. Numerous variations and changes can be made to the foregoing illustrative embodiments without departing from the scope and spirit of the present invention.

### REFERENCE NUMBERS

8 Hard top lift
10 Hard top
12 Receiver bar
14 Pivot post
16 Mast
18 Pivot plate
20 Interior pivot plate
21 Handle
22 Folding handle
23 Threaded aperture
24 Power junction box
25 Cord
26 Electrical switch
27 Switch
28 Receiver Hitch
30 Linear Actuator
31 Piston end
32 Actuator bracket
34 mounting plate
36 Bracket
38 Pivot support bar
40 Diagonal bracket
42 Capture plates
42a Front capture plate
42b Rear capture plate
43 Pad
44 Extension bar
45 Capture plate channel
46 Lift frame
47 Upper frame portion
47a Two parallel bars
47b Three parallel bars
48 Diagonal support
50 Lift frame post
52 Lift frame receiver
54 Handle
56 Threaded aperture
58 Aperture
60 Extension bar aperture
62 Connector
64 Back bottom edge
66 Gussett
68 Front portable stand
70 Left portable stand
72 Right portable stand
74 Capture plate channel
76 Front plate
78 Bottom plate
80 Rear plate

What is claimed is:

1. A vehicle hard top lift device, comprising:
a collapsible support frame further comprising a horizontal bar coupled to a vehicle hitch receiver extending away from a vehicle, a vertical tube that is rotationally attached at the bottom of said vertical tube to said horizontal bar, a pivot arm pivotally attached to the top of said vertical tube and said pivot arm extends towards said vehicle and a linear actuator linked to said vertical tube and said pivot arm;
a lift frame connected to an extension bar whereby said extension bar is slidable into and out of said pivot arm whereby the lift frame is adapted to fit in a rear cargo area of said vehicle and to come into contact with the interior top surface of the vehicle hard top;
a power source and a power cord connected to the linear actuator; and
a power switch.

2. The vehicle hard top lift device of claim 1 wherein the horizontal bar has a pivot post located on its top surface at the opposite end of where the horizontal bar attaches to the vehicle hitch receiver and whereby said vertical tube is hollow and is installed onto the pivot post.

3. The vehicle hard top lift device of claim 2 wherein the pivot post has a pivot plate located on its top surface and the vertical tube has an interior pivot plate located in the bottom interior of the vertical tube.

4. The vehicle hard top lift device of claim 1 further comprising at least one handle located on the vertical tube.

5. The vehicle hard top lift device of claim 1 further comprising two collapsible handles located on the vertical tube.

6. The vehicle hard top lift device of claim 1 further comprising two capture plates located on the top surface of the pivot arm.

7. The vehicle hard top lift device of claim 1 whereby the lift frame has an upper frame, a diagonal support, a post and a receiver whereby said diagonal support connects said upper frame to said post.

8. The vehicle hard top lift device of claim 7 further comprising a handle connected to the underside of the receiver of the lift frame receiver whereby the lift frame can easily be inserted into the rear cargo area of a vehicle.

9. The vehicle hard top lift device of claim 1 wherein the height of the vertical tube is between the length of forty-three to forty-four inches.

10. The vehicle hard top lift device of claim 1 further comprising a power junction box mounted to said vertical tube whereby an electrical connection is made with the linear actuator from the power junction box and where a switch is located on the power junction box and direct current is supplied to the power junction box via a cord from a vehicle direct current electrical outlet.

11. The vehicle hard top lift device of claim 1 further comprising a capture plate channel having a unitary body where the unitary body further comprises a front plate, a bottom plate and a rear plate purposed for attachment to the top surface of the pivot arm.

12. A vehicle hard top lift device, comprising:
a receiver bar connectable into a vehicle hitch receiver and said receiver bar having a pivot post located on the top of the receiver bar at the end of the receiver bar opposite the vehicle;
a mast insertable onto said pivot post;
a pivot support bar pivotally connected to the top of the mast and said pivot support bar extending towards said vehicle;
a linear actuator connected to the mast and to the pivot support bar;
a lift support frame connected to an extension bar whereby said extension bar is slidable into and out of said pivot support bar whereby the lift support frame is adapted to fit in a rear cargo area of said vehicle and to come into contact with the interior top surface of the vehicle canopy;
a power source and a power cord connected to the linear actuator; and
a power switch.

13. The vehicle hard top lift device of claim 12 wherein there are apertures in the receiver bar for insertion of a connector that achieves connection to the vehicle hitch receiver and allows for removal of said receiver bar, a gravity connection between the mast and the pivot post that allows for easy installation and removal, apertures located in the pivot support bar that allow connection via a connector to a bracket located on the top of the mast for installation and removal of the pivot support bar, a connection of the linear actuator on a piston end to a diagonal bracket located on the pivot support arm and connection of a base end of the linear actuator to an actuator bracket located on the mast, the extension bar having smaller dimensions such that it connects and slides into to the pivot support bar as the male component allowing for installation and removal of the extension bar, and apertures located in the extension bar for connection to apertures located on the lift support frame using a connector such that the receiver bar, the mast, the pivot support bar, the linear actuator, the extension bar and the lift support frame can be disassembled from their respective said connections and stored in a portable container.

14. The vehicle hard top lift device of claim 12 wherein the pivot post has a pivot plate located on its top surface and the mast has an interior pivot plate located in the bottom interior of the mast.

15. The vehicle hard top lift device of claim 12 further comprising at least one handle located on the mast.

16. The vehicle hard top lift device of claim 12 further comprising two collapsible handles located on the mast.

17. The vehicle hard top lift device of claim 12 further comprising two capture plates located on the top surface of the pivot support bar.

18. The vehicle hard top lift device of claim 12 whereby the lift support frame has an upper frame, a diagonal support, a post and a receiver whereby said diagonal support member connects said upper frame to said post.

19. The vehicle hard top lift device of claim 18 further comprising a removable handle connected to the underside of the receiver of the lift support frame.

20. The vehicle hard top lift device of claim 12 further comprising a power junction box mounted to said mast whereby an electrical connection is made with the actuator from the power junction box and where a switch is located on the power junction box and direct current is supplied to the power junction box via a cord from a vehicle direct current electrical outlet.

21. The vehicle hard top lift device of claim 12 wherein the height of the mast is between the length of forty-three to forty-four inches.

22. The vehicle hard top lift device of claim 12 further comprising a capture plate channel comprised of a front plate, a bottom plate and a rear plate purposed for attachment to the top surface of the pivot support bar.
